(19) United States
(12) Patent Application Publication
(10) Pub. No.: US 2017/0109443 A1
(43) Pub. Date: Apr. 20, 2017

(54) PROVIDING CLOUD-BASED HEALTH-RELATED DATA ANALYTICS SERVICES

(71) Applicant: FUJITSU LIMITED, Kawasaki-shi (JP)

(72) Inventor: I-wen TSOU, Palo Alto, CA (US)

(21) Appl. No.: 14/885,980

(22) Filed: Oct. 16, 2015

(51) Int. Cl. G06F 17/30; G06F 19/00

(52) U.S. Cl. CPC G06F 17/30864; G06F 19/322; G06F 19/3418

(57) ABSTRACT

A method to provide health-related data analytics services via a web service may include crawling, via a web crawler, the Internet to identify multiple websites with content related to human health. The method may also include obtaining, using text classification, multiple words associated with an occurrence in lives of people and multiple words associated with a health outcome in the lives of the people, performing text recognition to determine a frequency at which the words associated with the occurrence appear simultaneously with the words associated with a health outcome in the content of each of the websites identified by crawling the Internet, and confirming a proposed correlation between the occurrence and the health outcome in response to the frequency meeting a threshold.

The embodiments discussed in the present disclosure are related to cloud-based health-related data analytics services.

### BACKGROUND

Rising health care costs are a concern to many governments, organizations, and individuals around the world. Treatment of chronic disease, such as, for example, heart disease, stroke, diabetes, Alzheimer's Disease, lung disease, etc. in particular contributes significantly to the cost of health care. Treatment of acute disease also plays a role in the cost of health care.

The subject matter claimed in the present disclosure is not limited to embodiments that solve any disadvantages or that operate only in environments such as those described above. Rather, this background is only provided to illustrate one example technology area where some embodiments described may be practiced. Furthermore, unless otherwise indicated, the materials described in the background section are not prior art to the claims in the present application and are not admitted to be prior art by inclusion in this section.

### SUMMARY

According to an aspect of an embodiment, a method to provide health-related data analytics services via a web service may include crawling, via a web crawler, the Internet to identify multiple websites with content related to human health. The method may also include obtaining multiple words associated with an occurrence in lives of people and multiple words associated with a health outcome in the lives of the people, performing text recognition to determine a frequency at which the words associated with the occurrence appear simultaneously with the words associated with a health outcome in the content of each of the websites identified by crawling the Internet, and confirming a proposed correlation between the occurrence and the health outcome in response to the frequency meeting a threshold. The method may further include transmitting the confirmed proposed correlation to a user of the health-related data analytics services via an application program interface.

The object and advantages of the implementations will be realized and achieved at least by the elements, features, and combinations particularly pointed out in the claims.

It is to be understood that both the foregoing general description and the following detailed description are given as examples and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram of an example operating environment in which some embodiments may be implemented;

FIG. 2 is a block diagram of an example embodiment of a data analytics system that may be included in the operating environment of FIG. 1; and

FIG. 3 illustrates a flow diagram of an example method that may be implemented in the operating environment of FIG. 1.

### DESCRIPTION OF EMBODIMENTS

The prevalence of a negative health outcome, such as, for example, a particular disease, may be decreased through preventative care and/or by identifying various risk factors or occurrences in a life of an individual that may increase the individual's chance of experiencing the negative health outcome. Identification of occurrences that may increase the individual's chance of experiencing the negative health outcome may allow the individual to avoid the occurrences by, for example, implementing lifestyle changes, which in turn may decrease his or her chances of experiencing the negative health outcome. If the individual is able to avoid experiencing the negative health outcome in his or her life, this may decrease health care costs associated with providing care for the individual. Moreover, avoidance of the negative health outcome by individuals across populations may significantly decrease health care costs.

As referred to in the present disclosure, the term “occurrence” may refer to a risk factor that may increase an individual's chance of experiencing a health outcome, which may include a negative health outcome, or a preventative factor that may decrease the individual's chance of experiencing the health outcome. An occurrence may include, for example, an action, an environmental condition, a family history, a personal characteristic or temperament, a lifestyle, etc. Examples of particular occurrences that may increase the individual's chance of experiencing a particular health outcome may include, for example, stress, tobacco use, poor diet, physical inactivity, obesity, etc. Examples of particular occurrences that may decrease the individual's chance of experiencing a particular health outcome may include, for example, regular exercise, good diet, etc. An occurrence may be associated with a health outcome by being a risk factor for the health outcome or by being a preventative factor for the health outcome.

Some embodiments described in the present disclosure may relate to testing a proposed correlation between a particular occurrence in lives of people and a particular health outcome in the lives of the people. Many people share details of their lifestyle and/or health conditions online in blogs, discussion forums, social networking sites, etc. Moreover, healthcare provider websites, insurance company websites, and other types of websites may contain health-related content. The proliferation of websites on the Internet may make it increasingly hard to locate or identify websites that contain health-related content. Further, while information related to health may be readily available due to the large number of websites that contain health-related content on the Internet, organizing the information in a meaningful way to formulate relationships, theories, hypotheses, correlations, etc. is difficult. For example, determining whether an apparent correlation between a particular occurrence and a particular health outcome suggested in health-related content of a single website holds true across a vast number of other websites available on the Internet, is difficult.

Some embodiments described in the present disclosure may relate to providing data analytics services that may analyze content of various health-related websites to test the proposed correlation. In some embodiments, a web crawler may be used to crawl the Internet to identify multiple websites with content related to human health. In some embodiments, testing the proposed correlation using the data analytics services may yield a preliminary confirmation of the proposed correlation, which may be further tested through rigorous scientific study in a laboratory, research facility, etc.

In some embodiments, the data analytics services may implement machine learning and/or other data mining techniques to test the proposed correlation. For example, the data analytics services may implement one or more of the following: text recognition, language recognition, image recognition, and pattern recognition, as will be explained later in further detail. As such, the data analytics services may determine whether an apparent correlation between a particular occurrence and a particular health outcome suggested in health-related content of a single website holds true across a vast number of other websites available on the Internet. The data analytics services may also allow organization of information on the Internet in a meaningful way to formulate relationships, theories, hypotheses, correlations, etc. Thus, the data analytics services may allow testing of proposed correlation in a manner that a human could not perform, providing a technological solution to a technological problem. Additionally or alternatively, in some embodiments, the data analytics services may test the proposed correlation using data received from one or more sensors associated with tracked individuals.

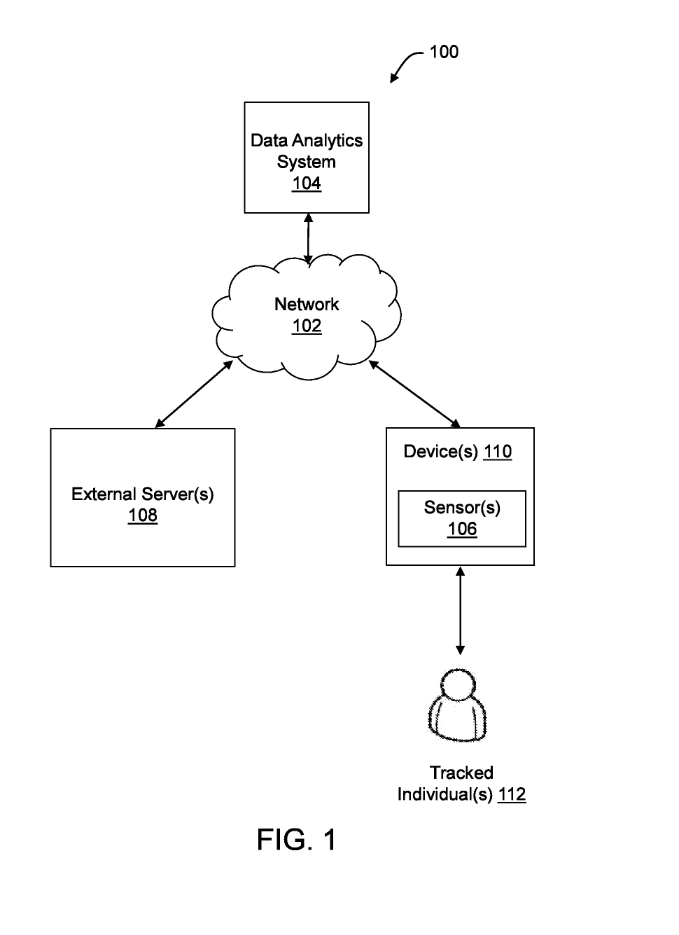

FIG. 1 illustrates a block diagram of an example operating environment 100 in which some embodiments may be implemented, arranged in accordance with at least one embodiment described in the present disclosure. The operating environment 100 may include a network 102, a data analytics system 104, one or more external servers 108, and one or more devices 110.

In general, the network 102 may include one or more wide area networks (WANs) and/or local area networks (LANs) that enable the data analytics system 104 to receive data from the one or more sensors 106 (hereinafter referred to as “sensor data”) and the one or more external servers 108. The WANs and/or the LANs may also enable the devices 110 to communicate with each other. In some embodiments, the network 102 includes the Internet, including a global internetwork formed by logical and physical connections between multiple WANs and/or LANs. Alternately or additionally, the network 102 may include one or more cellular RF networks and/or one or more wired and/or wireless networks such as, but not limited to, 802.xx networks, Bluetooth access points, wireless access points, IP-based networks, or the like. The network 102 may also include servers that enable one type of network to interface with another type of network.

In some embodiments, one or more tracked individuals 112 may include a human people whose activity may be monitored by the one or more sensors 106. In some embodiments, one or more of the tracked individuals 112 may communicate with the network 102 using a device 110 corresponding to the corresponding tracked individual 112. The device 110 may include, but is not limited to, a desktop computer, a laptop computer, a tablet computer, a mobile phone, a smartphone, a personal digital assistant (PDA), or other suitable computing device. In some embodiments, the device 110 may belong to the Internet of Things and/or may be wearable. In some embodiments, one or more sensors 106 may be part of the device 110 and/or may communicate with the device 110. In these and other embodiments, sensor data may be received by the device 110 and may be sent to the data analytics system 104 via the network 102.

The one or more sensors 106 may track one or more occurrences and/or one or more health outcomes experienced by a particular tracked individual 112 in his or her life. In the present disclosure, the term “sensor” may refer to a physical sensor that may sense or detect one or more indicators or parameters, such as, for example, an occurrence and/or a health outcome. Alternately or additionally, the term “sensor” may also refer to a system, apparatus, device, or module that may acquire information. In some embodiments, each of the sensors 106 may include one or more of the following: a location sensor, a schedule sensor, a heart rate sensor, a motion sensor, a sleep sensor, and other types of sensors. In some embodiments, the one or more sensors 106 may be included in or connected to one or more of the devices 110. In some embodiments, the one or more sensors 106 may be wirelessly connected to one or more of the devices 110. In some embodiments, a particular sensor 106 may be associated with a tracked individual 112 by sending data related to an occurrence and/or a health outcome in the life of the tracked individual. In some embodiments, the particular sensor 106 may be associated with the particular tracked individual 112, for example, by being included in or connected to one or more of the devices 110 that is associated with the particular tracked individual 112.

In some embodiments, the location sensor may be configured to detect or determine a location of a particular tracked individual 112. For example, the location sensor may include a GPS receiver, a Wi-Fi signal detector, a GSM signal detector, a Bluetooth beacon detector, an Internet Protocol (IP) address detector or any other system, apparatus, device, or module that may detect or determine a location of the particular tracked individual 112. In some embodiments, an occurrence in a life of the particular tracked individual 112 may include a location, which may be determined by the data analytics system 104 based on data received from the location sensor.

In some embodiments, the schedule sensor may include one or more systems, apparatuses, devices, or modules configured to extract schedule data from one or more calendars associated with a particular tracked individual 112. For example, the schedule sensor may be configured to extract schedule data from the Outlook® Calendar, Google Calendar™, or other electronic calendar associated with the particular tracked individual 112. In some embodiments, an occurrence in a life of the particular tracked individual 112 may include an activity that the particular tracked individual has engaged in or will engage in, which may be determined based on the schedule data. In some embodiments, an occurrence in the life of the particular tracked individual 112 may include an activity that occurs or has occurred in the life of the particular tracked individual 112 for a particular amount of time or a particular number of repetitions, which may be determined by the data analytics system 104 based on the schedule data.

In some embodiments, the heart rate sensor may be configured to measure or determine heart rate or indicators of heart rate. For example, the heart rate sensor may include one or more sensors configured to detect a pulse, a skin temperature, etc. of a particular tracked individual 112. In these or other embodiments, the heart rate sensor may include one or more systems, apparatuses, devices, or modules configured to determine the heart rate based on the detected indicators. In some embodiments, an occurrence in a life of the particular tracked individual 112 may include a heart rate of the particular tracked individual 112, a heart rate maintained by the particular tracked individual 112 for a particular amount of time, etc., which may be determined by the data analytics system 104 based on data received from one or more heart rate sensors. In some embodiments, a health outcome experienced by the particular tracked individual 112 may include a heart rate of the particular tracked individual 112, a heart rate maintained by the particular tracked individual 112 for a particular amount of time, etc., which may be determined by the data analytics system 104 based on data received from one or more heart rate sensors.

In some embodiments, the motion sensor may be configured to determine or detect motion of a particular tracked individual 112. For example, in some embodiments, the motion sensor may include any suitable system, apparatus, device, or routine capable of detecting or determining one or more of the following: tilt, shake, rotation, swing, and any other motion. In these or other embodiments, the motion sensor may include one or more of the following sensors: a gyroscope, an accelerometer, a magnetometer, a pedometer, a GPS receiver, and any other sensor that may detect motion. Additionally or alternatively, the motion sensor may include one or more systems, apparatuses, devices, or modules configured to determine motion based on the information that may be detected by the motion sensor. In some embodiments, an occurrence in a life of the particular tracked individual 112 may include a particular motion of the particular tracked individual 112, a reoccurrence of a particular motion over a particular period of time, etc., which may be determined by the data analytics system 104 based on data received from one or more motion sensors. For example, the occurrence may include walking a particular number of steps, walking a particular distance, walking the particular distance each day, etc.

In some embodiments, the sleep sensor may be configured to determine whether a particular tracked individual 112 is sleeping and/or to detect indicators that the particular tracked individual 112 is sleeping. In some embodiments, the sleep sensor may include a physical sensor capable of detecting indicators of whether the particular tracked individual 112 is sleeping, how much the particular tracked individual 112 has slept, the sleep patterns of the particular tracked individual 112, how well the particular tracked individual 112 has slept or a quality of the sleep of the particular tracked individual 112, etc. In these or other embodiments, the sleep sensor may include one or more systems, apparatuses, devices, or modules configured to determine that the particular tracked individual 112 is sleeping based on the indicators. In some embodiments, an occurrence in a life of the particular tracked individual 112 may include an amount of sleep of the particular tracked individual 112, an amount of sleep of the particular tracked individual 112 over a period of time, a pattern of sleep of the particular tracked individual 112, etc., which may be determined by the data analytics system 104 based on data received from one or more sleep sensors. In some embodiments, a health outcome in a life of the particular tracked individual 112 may include an amount of sleep of the particular tracked individual 112, an amount of sleep of the particular tracked individual 112 over a period of time, a pattern of sleep of the particular tracked individual 112, etc., which may be determined by the data analytics system 104 based on data received from one or more sleep sensors.

In some embodiments, the one or more external servers 108 may include or correspond to hardware devices that each include a processor and a memory. The external servers 108 may send and receive data to and from other entities of the system 100 via the network 102. For example, each of the external servers 108 may include or correspond to a web servers that may deliver Web pages to the data analytics system 104 via the network 102 for analysis by the data analytics system 104. In some embodiments, the Web pages may include websites with content related to human health, such as for example, blogs, discussion forums, social networking sites, healthcare provider websites, insurance company websites, and other types of websites. In some embodiments, the Web pages may include websites with content related to human health that are determined to be relevant to a particular proposed correlation by the data analytics system 104.

In some embodiments, the data analytics system 104 may be configured to provide data analytics services that may analyze content of various health-related websites to test a proposed correlation between a particular occurrence in lives of people and a particular health outcome in the lives of the people. In some embodiments, the data analytics system 104 may be configured to test the proposed correlation by obtaining a group of words associated with a particular occurrence of the proposed correlation and a group of words associated with the health outcome of the proposed correlation. In some embodiments, the data analytics system 104 may be configured to perform text recognition to determine a frequency at which the group of words associated with the particular occurrence appear simultaneously with the group of words associated with the health outcome in the content of each of the health-related websites determined to be relevant to the proposed correlation.

For example, a particular proposed correlation may include a correlation between a particular occurrence of malnutrition in lives of elderly people and a decrease in a particular health outcome of memory loss in the lives of the elderly people. In some embodiments, the group of words associated with the particular occurrence of malnutrition may include synonyms, approximate synonyms, and/or other words related to malnutrition, such as, for example, undernourishment, malnourishment, poor diet, inadequate diet, unhealthy diet, lack of food, etc. The group of words associated with the particular health outcome of memory loss may include synonyms, approximate synonyms, and/or other words related to memory loss, such as, for example, amnesia, inattention, obliviousness, blackout, absentmindedness, etc. In some embodiments, the group of words associated with the particular occurrence and/or health outcome may be determined using a text classifier, which may, for example, utilize term frequency and/or term weighting to classify or categorize words into one or more particular groups of words.

In some embodiments, the data analytics system 104 may be configured to determine the frequency at which the group of words associated with the particular occurrence appear simultaneously with the group of words associated with the particular health outcome. In some embodiments, the data analytics system 104 may be configured to determine the frequency by counting, in textual content of one or more health-related websites, a total number of words from the group of words associated with the particular occurrence and a total number of words from the group of words associated with the particular health outcome. In some embodiments, the data analytics system 104 may determine a frequency distribution for each of the groups of words based on the total numbers of words from the groups in the textual content of the particular health-related website. In some embodiments, the data analytics system 104 may be configured to compare the frequency distributions for each of the groups of words, and based on an overlap in the frequency distributions, the data analytics system 104 may be configured to determine the frequency at which the group of words associated with the particular occurrence appear simultaneously with the group of words associated with the particular health outcome.

Additionally or alternatively, in some embodiments, the data analytics system 104 may be configured to perform image recognition to determine the frequency at which the group of words associated with the particular occurrence appear simultaneously with the group of words associated with the health outcome in one or more health-related websites. For example, the data analytics system 104 may be configured to perform image recognition to determine whether a particular image found on a health-related website represents or is associated with a particular word of the group of words associated with the particular occurrence and/or a particular word of the group of words associated with the health outcome. In response to determining that the particular image is associated with the particular word, the data analytics system 104 may be configured to count the particular image towards a number of the particular word, which may be used by the data analytics system 104 to determine the frequency at which the group of words associated with the particular occurrence appear simultaneously with the group of words associated with the health outcome.

In addition to or as an alternative to statistical methods, in some embodiments, the data analytics system 104 may be configured to confirm the proposed correlation using natural language processing, such as, for example, part of speech tagging, syntactic parsing, and other types of linguistic analysis. Additionally or alternatively, in some embodiments, data mining, text mining, image clustering, correlation clustering, tagging, and/or parsing may be used to confirm the proposed correlation. Additionally or alternatively, machine learning, deep learning, and/or artificial intelligence may be used to confirm the proposed correlation.

In some embodiments, the data analytics system 104 may be configured to confirm the proposed correlation in response to the frequency meeting a particular threshold. In some embodiments, the proposed correlation may include a preliminary idea or suggestion that a user of the data analytics system 104 or other party associated with the data analytics system 104 would like to test and/or confirm. The data analytics system 104 may be configured to receive the proposed correlation, test the proposed correlation, and confirm the proposed correlation in response to the frequency meeting the particular threshold.

Also, in some embodiments, the data analytics system 104 may be configured to refine the proposed correlation to more specifically identify a subset of the particular occurrence that is associated with the health outcome. In some embodiments, the subset of the particular occurrence may include a possible source of the particular occurrence. For example, the particular occurrence may include “stress” and the subset of the particular occurrence may include a new baby, a quality of marriage, balancing work and family, etc. In some embodiments, the subset of the particular occurrence may include a type of the particular occurrence. For example, the particular occurrence may include “malnutrition,” and the subset of the particular occurrence may include protein-energy malnutrition, micronutrient deficiency, etc. Also, in some embodiments, the subset of the particular occurrence may include a time limitation. For example, the particular occurrence may include “malnutrition,” and the subset of the particular occurrence may include malnutrition over a six-month period. For example, the particular occurrence may include a particular lifestyle of “sedentary,” “active,” or “healthy eating,” and the subset of the particular occurrence may include “over five hours of television watching per day,” “biking three times per week,” and “eating five pieces of fruit per day,” respectively.

In some embodiments, the data analytics system 104 may be configured to perform text recognition and/or image recognition to determine a frequency at which a group of words associated with the subset of the particular occurrence appear simultaneously with the group of words associated with the particular occurrence. In these and other embodiments, the data analytics system 104 may be configured to update the proposed correlation to include the subset of the occurrence in response to the frequency meeting a particular threshold. For example, the subset of the occurrence may be included as a variable in the proposed correlation. In some embodiments, the data analytics system 104 may be configured to suggest the update to the proposed correlation, and the suggestion may be provided to the user of the data analytics system or another party associated with the data analytics system 104.

In some embodiments, the data analytics system 104 may be configured to perform pattern recognition to identify one or more occurrences and/or one or more subsets of occurrences associated with a particular health outcome. For example, the data analytics system 104 may be configured to use pattern recognition to identify one or more words that repeatedly occur simultaneously with the particular health outcome. In some embodiments, the data analytics system 104 may be configured to determine a frequency at which the one or more words occur simultaneously with a group of words associated with the particular health outcome. The words may be associated with a particular occurrence and/or a particular subset of an occurrence. In some embodiments, in response to the frequency meeting a threshold, the data analytics system 104 may be configured to update the proposed correlation to include the particular occurrence and/or the particular subset of the occurrence.

In some embodiments, the data analytics system 104 may be configured to determine a particular frequency at which a group of words associated with a subset of an occurrence appear simultaneously with the group of words associated with the particular health outcome in a same or similar manner as described with respect to determining a particular frequency at which a group of words associated with an occurrence appear simultaneously with a group of words associated with a particular health outcome. For example, the data analytics system 104 may be configured count, in textual content of one or more health-related websites, a total number of words from the group of words associated with the subset of the occurrence and a total number of words from the group of words associated with the particular health outcome and by determining a frequency distribution for each of the groups of words based on the total numbers of words from the groups in the textual content of the particular health-related website. In some embodiments, the data analytics system 104 may be configured to compare the frequency distributions for each of the groups of words, and based on an overlap in the frequency distributions, the data analytics system 104 may be configured to determine the frequency at which the group of words associated with the subset of the particular occurrence appear simultaneously with the group of words associated with the particular health outcome.

In some embodiments, the data analytics system 104 may be configured to determine one or more health-related websites that are relevant to the proposed correlation. In some embodiments, determining the health-related websites relevant to the proposed correlation may include selecting the relevant health-related websites from multiple websites available from the external server 108 via the network 102, such as, for example, health care provider websites, insurance company websites, online discussion forums, news websites, social networking websites, employer's benefit websites, community forum websites, lifestyle websites, etc.

In some embodiments, the data analytics system 104 may be configured to determine the health-related websites relevant to the proposed correlation based on the proposed correlation. For example, the proposed correlation may relate to or occur in a target population of individuals, and the health-related websites relevant to the proposed correlation may be determined based on the target population. The target population may include, for example, elderly people, teenagers, women, men, chronic disease patients, or any other population of individuals. If the proposed correlation is, for example, between a particular occurrence of an active social life in lives of elderly people and a decrease in a particular health outcome of memory loss in the lives of the elderly people, the target population may include elderly people. In response to the target population including, for example, elderly people, the health-related websites relevant to the proposed correlation may be determined to include websites directed to the elderly, such as, for example, senior health blogs, websites that include health and wellness information for older adults, online chat communities marketed to elderly people, etc.

In some embodiments, the data analytics system 104 may be configured to determine the health-related websites relevant to the proposed correlation based on an occurrence of the proposed correlation and/or a health outcome of the proposed correlation. For example, the occurrence of the proposed correlation may include military service, and based on the occurrence, the health-related websites relevant to the proposed correlation may be determined to include military blogs, military websites, etc. As another example, the health outcome of the proposed correlation may include cancer, and based on the health outcome, the health-related websites relevant to the proposed correlation may be determined to be cancer patient blogs, online cancer patient health journals, cancer support sites, etc.

In some embodiments, the data analytics system 104 may be configured to crawl, using a web crawler, the Internet to identify multiple websites with content relevant to the proposed correlation. For example, crawling the Internet may allow the data analytics system 104 to identify multiple websites with content related to human health and/or more specifically, to one or more of the following: the target population of the proposed correlation, the occurrence of the proposed correlation, and the health outcome of the proposed correlation. In some embodiments, the data analytics system 104 may distinguish between websites relevant and irrelevant to the proposed correlation by crawling the websites using the web crawler, such as, for example, BingBot, GoogleBot, etc.

In some embodiments, the data analytics system 104 may be configured to test a particular proposed correlation using only content from the health-related websites determined to be relevant to the proposed correlation. In some embodiments, the health-related websites determined to be relevant to the proposed correlation by the data analytics system 104 may include narratives or accounts of occurrences in lives of one or more individuals. A narrative may include a description of an individual's life. For example, the narratives may include or correspond to online blogs, journals, records, diaries, forums, etc. In some embodiments, the narratives may include one or more of the following: health outcomes experienced by individuals, occurrences in lives of the individuals, and subsets of the occurrences in the lives of the individuals.

In some embodiments, the data analytics system 104 may determine that a website includes a narrative by scanning the website and analyzing the content. The data analytics system 104 may analyze the content to determine, for example, whether the content includes references to multiple dates or times, chronological posts or entries, posts dated at later times than other posts, a threshold number of references to “I” or “my,” which may be indicators of the website including a narrative.

In some embodiments, in response to textual content of the health-related websites including one or more narratives, the data analytics system 104 may be configured to perform language recognition with respect to the narratives to determine a frequency at which the occurrence of the proposed correlation and/or the subset of the occurrence of the proposed correlation occurs earlier in time than the health outcome of the proposed correlation, as told by the narratives. For example, a health-related website may include the following comment:
My name is Dana, and I was diagnosed with breast cancer in Feb. 2012. My son was diagnosed with schizophrenia back when he was 16 and a half. My husband lost about four jobs prior to my diagnosis, and we were on the brink of losing our home. This caused so much stress in my life, and so I can definitely say that cancer is stress driven.
   Language recognition may be used to determine, based on the comment, that a particular occurrence of stress occurred earlier in time than a particular health outcome of breast cancer. By using language recognition to analyze the comment and additional narratives found on multiple health-related websites, the data analytics system 104 may determine the frequency at which the particular occurrence of stress and/or a subset of the occurrence of stress occurs earlier in time than the health outcome of breast cancer in the multiple health-related websites. Language recognition may allow analysis of narratives found on a vast number of health-related websites in a short period of time; a human would be incapable of such analysis. Using language recognition, the data analytics system 104 may quickly determine the frequency at which the occurrence of the proposed correlation and/or the subset of the occurrence of the proposed correlation occurs earlier in time than the health outcome of the proposed correlation.

Additionally or alternatively, in some embodiments, the narratives may include one or more dates and/or times, such as, for example, a date and/or time stamp indicating when a post was made to a blog or other narrative. In these and other embodiments, the data analytics system 104 may be configured to determine the frequency at which the occurrence and/or the subset of the occurrence occurs earlier in time than the health outcome, as told by the narratives, based on the dates and/or times associated with the narratives.

In some embodiments, the sensor data received by the data analytics system 104 may indicate one or more occurrences in the lives of one or more of tracked individuals 112 tracked by the data analytics system 104. In some embodiments, the sensors may also indicate one or more patterns of occurrences in the lives of the tracked individuals 112. In some embodiments, the sensors may further indicate one of more health outcomes in the lives of the tracked individuals 112. In some embodiments, the data analytics system 104 may be configured to perform pattern recognition to determine that a particular occurrence and/or a particular pattern of occurrences is associated with a particular health outcome.

In some embodiments, pattern recognition may allow analysis of large amounts of sensor data from multiple tracked individuals 112 in a short period of time, which a human would be incapable of. Using pattern recognition, the data analytics system 104 may quickly determine a frequency at which the particular occurrence and/or the particular pattern of occurrences is associated with the particular health outcome.

In some embodiments, in response to a particular frequency at which a group of words associated with a particular occurrence and/or a group of words associated with a particular subset of the particular occurrence appear simultaneously with the group of words associated with a particular health outcome meeting a particular threshold, the data analytics system 104 may be configured to present the particular occurrence to a user of the data analytics system or another party associated with the data analytics system 104, such as an administrator of the data analytics system 104 or a researcher. In some embodiments, the user and/or the other party may decide to further test whether the particular occurrence and/or the particular subset of the particular occurrence is associated with the particular health outcome in a laboratory, hospital, or other research facility.

Modifications, additions, or omissions may be made to the example operating environment 100 without departing from the scope of the present disclosure. For example, in some embodiments, the example operating environment 100 may include any number of other components that may not be explicitly illustrated or described. For example, the example operating environment 100 may not include the sensors 106 and/or the devices 110. As another example, the example operating environment 100 may include one or more servers, such as, for example, a location server, schedule server, or another server not illustrated, which may be used to provide sensor data to the data analytics system 104. As a further example, one or more users (not illustrated in FIG. 1) of the data analytics system 104 may be associated with one or more user devices (not illustrated in FIG. 1), which may connected to the data analytics system 104 via the network 102 and/or an application program interface.

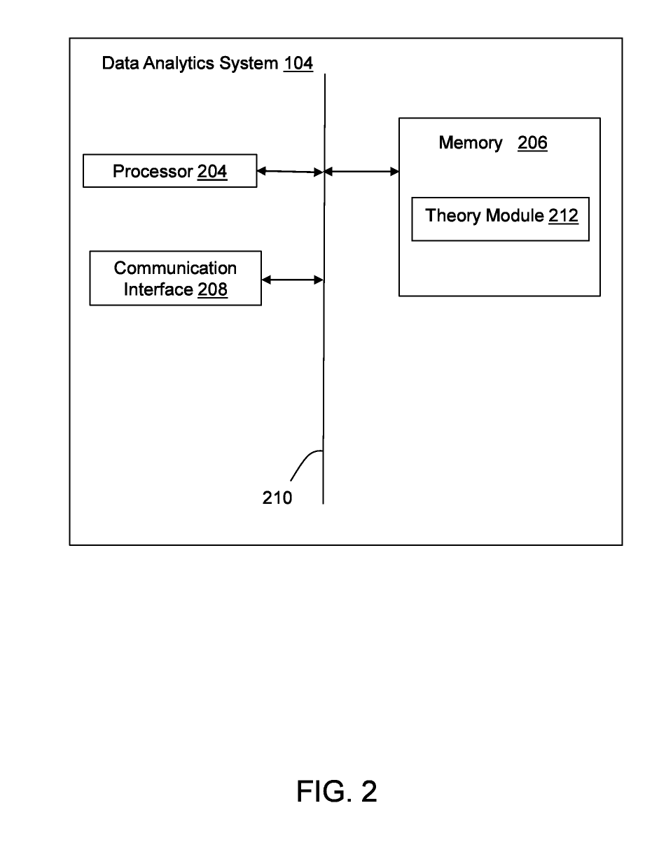

FIG. 2 is a block diagram of an example embodiment of the data analytics system 104 of FIG. 1, arranged in accordance with at least one embodiment described in the present disclosure. As illustrated, the data analytics system 104 may include a processor 204, a memory 206, and a communication interface 208. The processor 204, the memory 206, and the communication interface 208 may be communicatively coupled via a communication bus 210. The communication bus 210 may include, but is not limited to, a memory bus, a storage interface bus, a bus/interface controller, an interface bus, or the like, or any combination thereof.

In general, the communication interface 208 may facilitate communications over a network, such as the network 102 of FIG. 1. The communication interface 208 may include, but is not limited to, a network interface card, a network adapter, a LAN adapter, or other suitable communication interfaces.

The processor 204 may be configured to execute computer instructions that cause the data analytics system 104 to perform the functions and operations described in the present disclosure. For example, in general, the processor 204 may be configured to determine one or more websites with content related to human health. As another example, the processor 204 may be configured to test a proposed correlation between an occurrence in lives of people and a health outcome in the lives of the people. The processor 204 may include, but is not limited to, a processor, a multi-core processor, a microprocessor (μP), a controller, a microcontroller (μC), a central processing unit (CPU), a digital signal processor (DSP), any combination thereof, or other suitable processor.

In some embodiments, computer instructions may be loaded into the memory 206 for execution by the processor 204 as described above. For example, the computer instructions may be in the form of one or more modules, such as, but not limited to, a theory module 212. In some embodiments, data generated, received, and/or operated on during performance of the functions and operations may be at least temporarily stored in the memory 206. Moreover, the memory 206 may include volatile storage such as random access memory (RAM). More generally, the data analytics system 104 may include a tangible computer-readable storage medium such as, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible computer-readable storage medium.

Modifications, additions, or omissions may be made to the data analytics system 104 without departing from the scope of the present disclosure. For example, in some embodiments, the data analytics system 104 may include any number of other components that may not be explicitly illustrated or described. For example, the data analytics system 200 may include one or more databases, which may store various information about tracked individuals, such as, for example, sensor data associated with the tracked individuals.

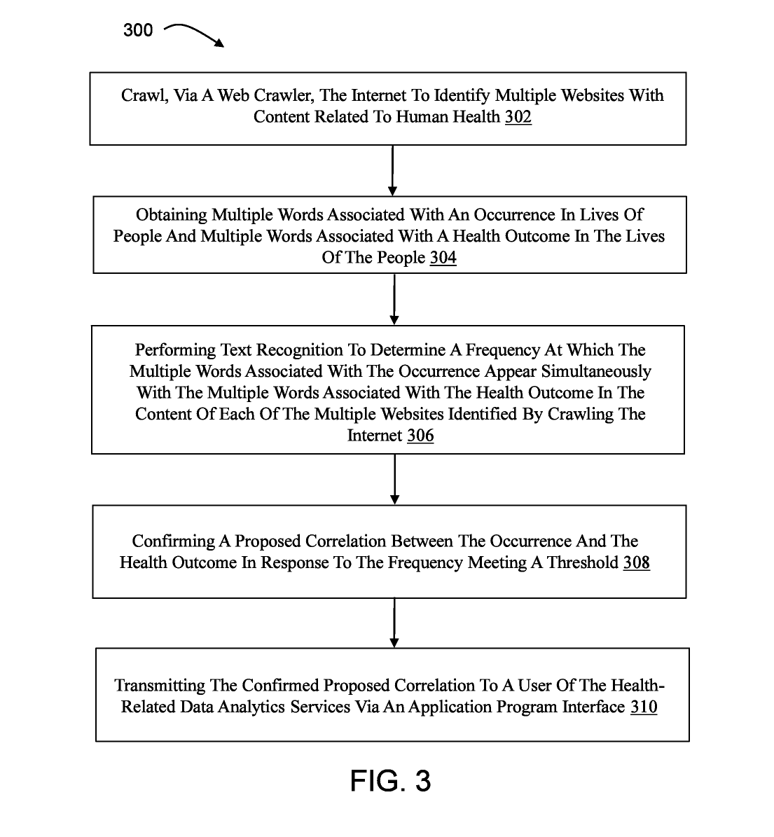

FIG. 3 illustrates a flow diagram of an example method 300 that may be implemented in the operating environment of FIG. 1, arranged in accordance with at least one embodiment described in the present disclosure. The method 300 may include a method of providing health-related data analytics services via a web service. One or more operations associated with the method 300 may be implemented, in whole or in part and individually or collectively, by the data analytics system 104 of FIGS. 1 and 2. For example, the processor 204 of FIG. 2 may be configured to perform one or more of the operations associated with the method 300 by executing program instructions of the theory module 212. Although illustrated as discrete blocks, various blocks may be divided into additional blocks, combined into fewer blocks, or eliminated, depending on the desired implementation.

The method 300 may begin at block 302, where the Internet may be crawled, via a web crawler, to identify multiple websites with content related to human health. Block 302 may be followed by block 304. At block 304, multiple words associated with the occurrence and multiple words associated with the health outcome may be obtained. The multiple words associated with the occurrence and multiple words associated with the health outcome may be obtained, for example, using text classification. Block 304 may be followed by block 306.

At block 306, text recognition may be performed to determine a frequency at which the multiple words associated with the occurrence appear simultaneously with the multiple words associated with the health outcome in content of each of the multiple websites identified by crawling the Internet. Block 306 may be followed by block 308. At block 308, a proposed correlation between an occurrence in lives of people and a health outcome in the lives of the people may be confirmed in response to the frequency meeting a threshold. Block 308 may be followed by block 310.

At block 310, the confirmed proposed correlation may be transmitted to a user of the health-related data analytics services via an application program interface. In some embodiments, the application program interface may be configured to allow a provider of the data analytics services to access a portion of the content of the plurality of websites. One skilled in the art will appreciate that, for this and other processes and methods disclosed in the present disclosure, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For example, in some embodiments, the method 300 may include providing an application program interface configured to invoke the health-related data analytics services via the web service. In some embodiments, the application program interface may be used to retrieve content from one or more websites for analysis. For example, the application program interface may be configured to allow users of the data analytics services to feed content of one or more websites associated with the user to the data analytics server. In some embodiments, a particular user may have a preference to share only a portion of content of a website associated with the particular user and may indicate this preference via the application program interface. As another example, additionally or alternatively, in some embodiments, method 300 may include, in response to the content of the websites including one or more narratives, performing language recognition with respect to the narratives to determine a particular frequency at which the occurrence occurs earlier in time than the health outcome as told by the narratives; and confirming the proposed correlation in response to the particular frequency meeting a particular threshold.

Additionally or alternatively, in some embodiments, the method 300 may include one or more of the following: obtaining sensor data from sensors associated with the people; determining a particular frequency at which the occurrence occurs before the outcome in the lives of the people based on time data associated with the sensor data; and confirming the proposed correlation in response to the particular frequency meeting a particular threshold. In some embodiments, the sensor data may indicate the occurrence and the outcome in the lives of the people.

As another example, in some embodiments, the method 300 may also include refining the proposed correlation between the occurrence and the health outcome. In some embodiments, refining the proposed correlation between the occurrence and the health outcome may include one or more of the following: performing text recognition to determine a particular frequency at which multiple words associated with a subset of the occurrence appear simultaneously with multiple words for the health outcome in the content of each of the websites; and updating the proposed correlation to include the subset of the occurrence in the proposed correlation in response to the particular frequency meeting a particular threshold.

Additionally or alternatively, in some embodiments, refining the proposed correlation between the occurrence and the health outcome may include one or more of the following: in response to the content of the websites including one or more narratives, performing language recognition with respect to the narratives to determine a particular frequency at which the subset of the occurrence occurs earlier in time than the health outcome as told by the narratives; and updating to the proposed correlation to include the subset of the occurrence in the proposed correlation in response to the particular frequency meeting a particular threshold.

Additionally or alternatively, in some embodiments, the method 300 may include one or more of the following: obtaining sensor data from sensors associated with the people; determining a particular frequency at which the other occurrence occurs prior to the health outcome in the lives of the people based on the sensor data; and determining an additional correlation between the other occurrence and the health outcome in response to the particular frequency meeting a particular threshold; and refining the proposed correlation to include the determined additional correlation. In some embodiments, the sensor data may indicate another occurrence and the health outcome in the lives of the people

Additionally or alternatively, in some embodiments, the method 300 may include one or more of the following: obtaining sensor data from sensors associated with the people; determining a particular frequency at which the other occurrence occurs prior to the health outcome in the lives of the people based on the sensor data; determining an additional correlation between the other occurrence and the health outcome in response to the particular frequency meeting a particular threshold; and refining the proposed correlation to include the determined additional correlation. In some embodiments, the sensor data may indicate another occurrence and the health outcome in the lives of the people. In some embodiments, the sensor may include or correspond to one of the sensors 106 of FIG. 1.

While some of the systems and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A computer-implemented method of providing health-related data analytics services via a web service, comprising:
crawling, via a web crawler, the Internet to identify a plurality of websites with content related to human health;
obtaining, using text classification, a plurality of words associated with a lifestyle of people and a plurality of words associated with a health outcome in lives of the people;
performing text recognition to determine a frequency at which the plurality of words associated with the lifestyle appear simultaneously with the plurality of words associated with the health outcome in the content of each of the plurality of websites identified by crawling the Internet;
confirming a proposed correlation between the lifestyle and the health outcome in response to the frequency meeting a threshold; and
transmitting the confirmed proposed correlation to a user of the health-related data analytics services via an application program interface, the application program interface configured to allow a provider of the data analytics services to access a portion of the content of the plurality of websites.

2. The method of claim 1, further comprising refining the proposed correlation between the lifestyle and the health outcome, including:
performing text recognition to determine another frequency at which a plurality of words associated with a subset of the lifestyle appear simultaneously with the plurality of words associated with the health outcome in the content of each of the plurality of websites; and
updating the proposed correlation to include the subset of the lifestyle in the proposed correlation in response to the other frequency meeting another threshold.

3. The method of claim 2, wherein refining the proposed correlation between the lifestyle and the health outcome further includes:
in response to the content of the plurality of websites including one or more narratives, performing language recognition with respect to the narratives to determine an additional frequency at which the subset of the lifestyle occurs earlier in time than the health outcome as told by the narratives; and
updating the proposed correlation to include the subset of the lifestyle in the proposed correlation in response to the additional frequency meeting an additional threshold.

4. The method of claim 1, further comprising:
in response to the content of the plurality of websites including one or more narratives, performing language recognition with respect to the narratives to determine another frequency at which the lifestyle occurs earlier in time in the lives of the people than the health outcome as told by the narratives; and
confirming the proposed correlation in response to the other frequency meeting another threshold.

5. The method of claim 1, further comprising:
obtaining sensor data from sensors associated with the people, wherein the sensor data indicates the lifestyle and the health outcome;
determining another frequency at which the lifestyle occurs before the health outcome based on time data associated with the sensor data; and
confirming the proposed correlation in response to the other frequency meeting another threshold.

6. The method of claim 1, further comprising
obtaining sensor data from sensors associated with the people, wherein the sensor data indicates another lifestyle of the people and the health outcome;
determining another frequency at which the other lifestyle occurs in the lives of the people prior to the health outcome in the lives of the people based on the sensor data;
determining an additional correlation between the other lifestyle and the health outcome in response to the other frequency meeting another threshold; and
refining the proposed correlation to include the determined additional correlation.

7. A system comprising:
memory with instructions stored thereon;
a processor communicatively coupled to the memory and configured to, in response to executing the instructions stored on the memory, cause the system to:
crawl, via a web crawler, the Internet to identify a plurality of websites with content related to human health;
obtain a plurality of words associated with an occurrence in lives of people and a plurality of words associated with a health outcome in the lives of the people;
in response to the content of the plurality of websites including one or more narratives, perform language recognition with respect to the narratives to determine a frequency at which the occurrence occurs earlier in time than the health outcome as told by the narratives;
confirm a proposed correlation between the occurrence and the health outcome in response to the frequency meeting a threshold; and
transmit the confirmed proposed correlation to a user of the health-related data analytics services via an application program interface.

8. The system of claim 7, wherein the processor is further configured to cause the system to refine the proposed correlation between the occurrence and the health outcome by being configured to:
perform text recognition to determine another frequency at which a plurality of words associated with a subset of the occurrence appear simultaneously with the plurality of words associated with the health outcome in the content of each of the plurality of websites; and
update the proposed correlation to include the subset of the occurrence in the proposed correlation in response to the other frequency meeting another threshold.

9. The system of claim 8, wherein the processor is configured to cause the system to refine the proposed correlation between the occurrence and the health outcome by being further configured to:
in response to the content of the plurality of websites including one or more narratives, perform language recognition with respect to the narratives to determine an additional frequency at which the subset of the occurrence occurs earlier in time than the health outcome as told by the narratives; and
update the proposed correlation to include the subset of the occurrence in the proposed correlation in response to the additional frequency meeting an additional threshold.

10. The system of claim 7, wherein the processor is configured to:
perform text recognition to determine another frequency at which the plurality of words associated with the occurrence appear simultaneously with the plurality of words associated with the health outcome in the content of each of the plurality of websites; and
confirm the proposed correlation between the occurrence and the health outcome in response to the other frequency meeting another threshold.

11. The system of claim 7, wherein the processor is configured to:
obtain sensor data from sensors associated with the people, wherein the sensor data indicates the occurrence and the health outcome;
determine another frequency at which the occurrence occurs before the health outcome based on time data associated with the sensor data; and
confirm the proposed correlation in response to the other frequency meeting another threshold.

12. The system of claim 7, wherein the processor is further configured to cause the system to refine the proposed correlation between the occurrence and the health outcome by being configured to:
obtain sensor data from sensors associated with the people, wherein the sensor data indicates another occurrence and the health outcome;
determine another frequency at which the other occurrence occurs prior to the health outcome based on the sensor data;
determine an additional correlation between the other occurrence and the health outcome in response to the other frequency meeting another threshold; and
refine the proposed correlation to include the determined additional correlation.

13. One or more non-transitory computer-readable media that include instructions stored thereon that are executable by one or more processors to perform or control performance of operations to provide health-related data analytics services via a web service, the operations comprising:
crawling, via a web crawler, the Internet to identify a plurality of websites with content related to human health;
obtaining a plurality of words associated with an occurrence in lives of people and a plurality of words associated with a health outcome in the lives of the people;
performing text recognition to determine a frequency at which the plurality of words associated with the occurrence appear simultaneously with the plurality of words associated with the health outcome in the content of each of the plurality of websites identified by crawling the Internet;
confirming a proposed correlation between the occurrence and the health outcome in response to the frequency meeting a threshold; and
transmitting the confirmed proposed correlation to a user of the health-related data analytics services via an application program interface.

14. The one or more non-transitory computer-readable media of claim 13, wherein the operations further comprise:
performing text recognition to determine another frequency at which a plurality of words associated with a subset of the occurrence appear simultaneously with the plurality of words associated with the health outcome in the content of each of the plurality of websites; and
updating the proposed correlation to include the subset of the occurrence in the proposed correlation in response to the other frequency meeting another threshold.

15. The one or more non-transitory computer-readable media of claim 14, wherein refining the proposed correlation between the occurrence and the health outcome further includes:
in response to the content of the plurality of websites including one or more narratives, performing language recognition with respect to the narratives to determine an additional frequency at which the subset of the occurrence occurs earlier in time than the health outcome as told by the narratives; and
updating the proposed correlation to include the subset of the occurrence in the proposed correlation in response to the additional frequency meeting an additional threshold.

16. The one or more non-transitory computer-readable media of claim 13, further comprising:
in response to the content of the plurality of websites including one or more narratives, performing language recognition with respect to the narratives to determine another frequency at which the occurrence occurs earlier in time than the health outcome as told by the narratives; and
confirming the proposed correlation in response to the other frequency meeting another threshold.

17. The one or more non-transitory computer-readable media of claim 13, wherein testing the proposed correlation between the occurrence and the health outcome further includes:
obtaining sensor data from sensors associated with the people, wherein the sensor data indicates the occurrence and the health outcome;
determining another frequency at which the occurrence occurs before the health outcome based on time data associated with the sensor data; and
confirming the proposed correlation in response to the other frequency meeting another threshold.

18. The one or more non-transitory computer-readable media of claim 13, wherein the operations further comprises:
obtaining sensor data from sensors associated with the people, wherein the sensor data indicates another occurrence and the health outcome;
determining another frequency at which the other occurrence occurs prior to the health outcome based on the sensor data;
determining an additional correlation between the other occurrence and the health outcome in response to the other frequency meeting another threshold; and
refining the proposed correlation to include the determined additional correlation.

19. The one or more non-transitory computer-readable media of claim 13, wherein the application program interface configured to allow a provider of the data analytics services to access a portion of the content of the plurality of websites.

20. The one or more non-transitory computer-readable media of claim 13, wherein the plurality of words associated with the occurrence and a plurality of words associated with the health outcome are obtained using text classification.
